(19) United States
(12) Patent Application Publication
(10) Pub. No.: US 2004/0129550 A1
(43) Pub. Date: Jul. 8, 2004

(54) Pressure-tight contact device

(76) Inventors: Marc Bodet, Northen (DE); Klaus Egeter, Landesbergen (DE); Hartmut Geiger, Garbsen (DE); Nico Herzberg, Hannover (DE); Siegfried Hofler, Hannover (DE)

Correspondence Address: Kramer Levin Naftalis & Frankel LLP, 919 Third Avenue, New York, NY, 10022, US

(21) Appl. No.: 10/733,124

(22) Filed: Dec. 11, 2003

(30) Foreign Application Priority Data
Dec. 14, 2002 (DE) 102 58 576.8

(51) Int. Cl. H01H 13/14

(52) U.S. Cl. 200/520

(57) ABSTRACT

A pressure-tight contact device, especially for use in a pressure-tight encapsulated motor of a compressor. The contact device includes a connector shell, which can be pressed onto an insulator and is fastened to the pressure-tight housing enclosing the motor. The motor is connected by means of electrical connecting leads to at least one contact pin. The pin passes through the insulator and a punched opening of a contact tab for connection to a connecting cable. The individual parts of the contact device are sealed relative to one another by means of O-rings. The connector shell has a shroud member which can be formed in various configurations desired by the user for connection to various types of connecting cables.

### BACKGROUND OF THE INVENTION

The present invention is directed generally to a pressure-tight contact device, especially of the type used in a pressure-tight encapsulated electric motor for driving a compressor.

In air suspension systems for road vehicles wherein level regulation of the vehicle can also be achieved at the same time, compressed air is needed to supply the air suspension bellows. In this way, the level of the cargo surface of a heavy truck or the ground clearance of a passenger car can be kept constant even if the load fluctuates.

Such level regulation is known, for example, from WABCO's brochure entitled “ECAS—Electronic controlled air suspension system: Level regulation for commercial vehicles” published in February, 1996. In such systems for heavy trucks, the compressed air used for raising the vehicle or for increasing the pressure in the spring bellows is drawn from the normal compressed air supply system of the truck. To lower the vehicle, the surplus compressed air is vented to the atmosphere (open system). Consequently, the compressor consumes undesirable amounts of energy due to constant regeneration of compressed air.

For this reason, manufacturers are switching to the use of closed or partly closed systems, especially for self-leveling systems of passenger cars. In closed systems, the surplus compressed air is not vented to the atmosphere when the vehicle is lowered, but instead is returned by the compressor to the pressure tank. In partly closed systems, air lost through leaks can be replaced as needed from the atmosphere.

For this purpose, it is known that the compressor and the electric motor that drives it can be disposed in a common pressure tank. This reduces the load on the compressor, since compressed air acts on both sides of its delivery piston, which is equipped with a check valve (see e.g., DE 100 05 929 C2 and DE 100 55 108 A1).

Nevertheless, such common encapsulation of motor and compressor suffers from the disadvantage that the electric leads supplying current to the electric motor as well as further signal lines that may be needed must be brought out from the common encapsulation without compromising pressure-tightness. These leads are attached to a terminal socket or to a contact device for an electric connecting cable.

Accordingly, it is desired to provide a pressure-tight contact device of the type used in a pressure-tight encapsulated electric motor for driving a compressor that can be manufactured simply and inexpensively, is durably pressure-tight and has an electric terminal socket that is suitable for use with various connecting cables.

### SUMMARY OF THE INVENTION

Generally speaking, in accordance with the present invention, a pressure-tight contact device is provided which avoids the disadvantages of prior art devices.

The contact device according to a preferred embodiment of the present invention includes an insulator extending through a pressure-tight housing, a seal sealing the insulator to the housing, and a connector shell of insulating material positioned on the insulator and affixed to the insulator or the housing. The connector shell includes a terminal socket with at least one contact pin for receiving a connecting cable. The connecting cable is electrically connected to an electrical device housed in the pressure-tight housing.

In an advantageous embodiment of the present invention, the connector shell is one of a set of interchangeable connector shells, each having a different configuration for use with a corresponding connecting cable.

In yet another advantageous embodiment of the present invention, the contact pin extends through the insulator. The seal comprises a first O-ring sealing the insulator to the housing. A second O-ring is provided for sealing the insulator to the pin, and a third O-ring is provided for sealing the insulator to the shell.

An advantage of the inventive contact device is that, on the one hand, it is made of uniform parts, namely contact pins for connection of the motor and an insulator in which the contact pins are supported, while on the other hand a custom-shaped connector shell can be fitted onto the insulator for connection to various kinds of connecting cables. Thus, the contact device can be easily manufactured and also easily modified for use with different connecting cables depending on the user or vehicle manufacturer—avoiding the need to maintain an inventory of different connector versions.

Additionally, the use of O-rings, provides sealing capabilities that are superior to known alternatives such as sealing by potting or all-round injection molding, even in the presence of fluctuating temperatures.

Accordingly, it is an object of the present invention to provide a pressure-tight contact device, especially for use with a pressure-tight encapsulated compressor motor, that is cost effective to manufacture and assemble and that is easily adapted for use with various connecting cables.

Still other objects and advantages of the present invention will in part be obvious and will in part be apparent from the specification.

The present invention accordingly comprises the features of construction, combination of elements, and arrangement of parts which will be exemplified in the constructions hereinafter set forth, and the scope of the invention will be indicated in the claims.

### BRIEF DESCRIPTION OF THE DRAWINGS

For a fuller understanding of the invention, reference is had to the following description taken in connection with the accompanying drawings in which:

FIG. 1 is a cross-sectional view of a pressure-tight contact device constructed in accordance with a preferred embodiment of the present invention;

FIG. 2 is a cross-sectional view of a pressure-tight contact device constructed in accordance with an alternative embodiment of the present invention;

FIG. 3 is a top view of a contact tab of the inventive pressure-tight contact device constructed in accordance with a preferred embodiment of the present invention;

FIG. 4 is a side view of the contact tab depicted in FIG. 3;

FIG. 5 is a front view of one embodiment of a cable terminal socket of the inventive pressure-tight contact device; and

FIG. 6 is a top view of an alternative embodiment of a cable terminal socket of the inventive pressure-tight contact device showing a connecting cable plugged therein.

### DETAILED DESCRIPTION OF THE PREFERRED EMBODIMENTS

Referring now to the drawing figures where like reference numerals are used for corresponding parts, FIG. 1 shows a cross section of one embodiment of the inventive contact device. Reference numeral (1) denotes a pressure-tight housing in which there is installed an electric motor (12) for driving a compressor. A gas or fluid pressure of 10 bar, for example, can be maintained in housing (1). Motor (12) is connected by a lead (21) to a contact pin which can be one of a set of two or more contact pins (4). Contact pins (4) are pressed from underneath into an insulator (2), and are mechanically retained therein by projecting serrations (13). Sealing between insulator (2) and contact pin (4) is provided by an O-ring (5).

Insulator (2) is sealed relative to housing (1) with a further O-ring (3). With this construction, escape of pressurized fluid from housing (1) is prevented.

A connector shell (7) sealed relative to insulator (2) with a further O-ring (8) is fitted (e.g., slipped or forced) onto insulator (2) from underneath. Connector shell (7) is immovably joined to housing (1) by fastening means (9, 10; 22, 23). While in FIG. 1, this is accomplished by bolts (9, 10), it should be understood that it is also possible to screw connector shell (7) onto insulator (2).

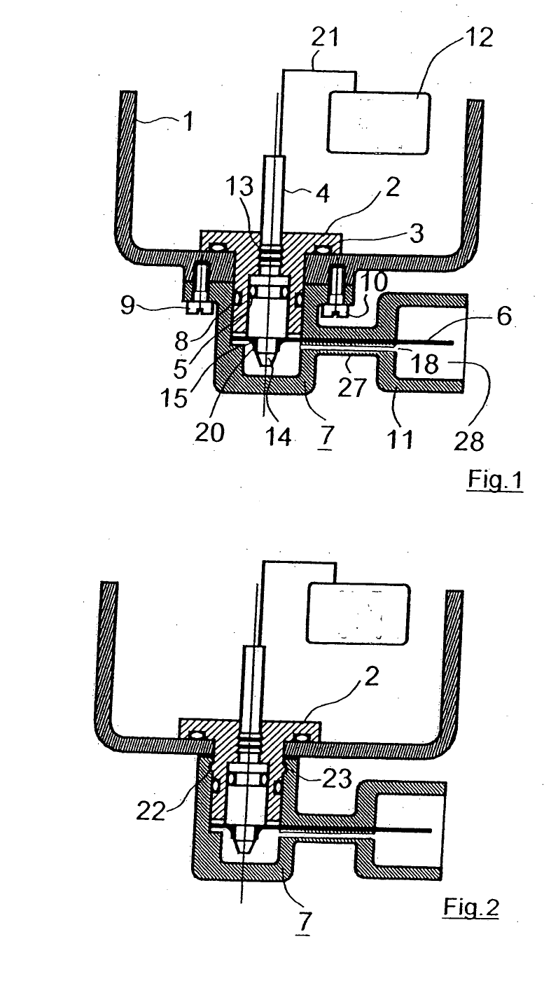

Referring now to FIG. 2, the connector shell (7) and insulator (2) are joined to one another preferably by a play-free snap fastener. This comprises, for example, noses (22, 23) which are molded onto connector shell (7) and engage in complementary recesses of insulator (2).

In both cases described above, secure fastening of connector shell (7) to insulator (2) or to housing (1) is accomplished.

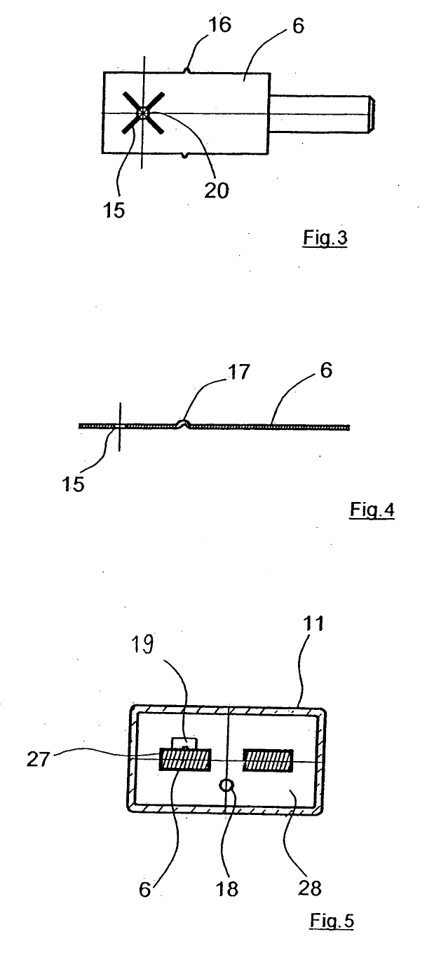

When connector shell (7) is fitted onto insulator (2), a tip (14) of contact pin (4) passes through an opening (15) punched in a flat contact tab (6) (see FIG. 3). In this way, punched opening (15) forms a plurality of contact faces (20), which in assembled condition of the contact device bear with high initial clamping force on contact pin (4) and achieve a good electrically conductive connection between contact pin (4) and contact tab (6).

Contact tab (6) is mounted in a slot (27) of connector shell (7) and is fixed in connector shell (7) by noses (16) or by a crimp (17) (see FIG. 4). In this way, contact tab (6) is protected against falling out during the assembly process.

Relative to connector shell (7), contact tab (6) preferably has sufficient play to prevent mechanical stresses from developing during expansion caused by high ambient temperatures.

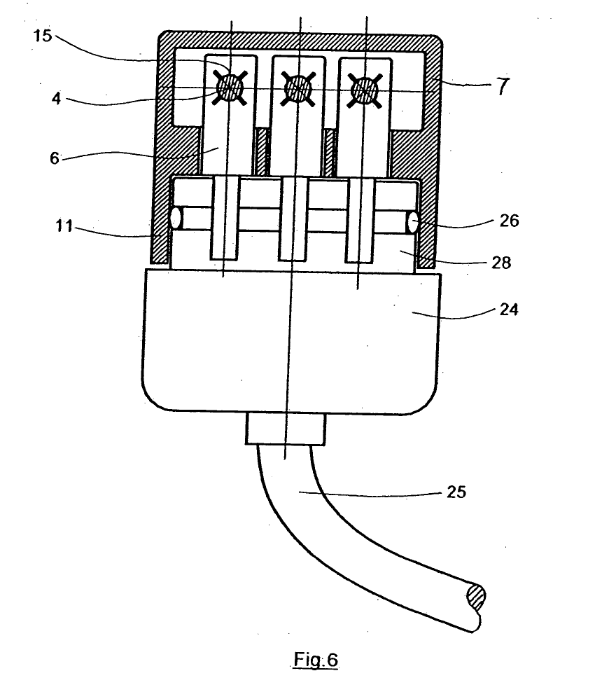

The portion of contact tab (6) remote from contact pin (4) projects into a shroud member (11) which forms a terminal socket (28) for a connecting cable (25) (see FIG. 6).

FIG. 5 is a front top view of terminal socket (28) which in the embodiment shown has a two-pin configuration. Terminal socket (28) is joined to connector shell (7), together with shroud member (11) and the two adjacent contact tabs (6). Connector shell (7) can be equipped with a test bore (18) to check for leaks. Such leak tests are known to those of ordinary skill in the art. Instead of a test bore (18), a test channel (19) disposed above one contact tab (6) can also be used for the leak test.

FIG. 6 is a top view of terminal socket (28) of connector shell (7) which in the embodiment shown has a three-pin configuration. In this case, connector shell (7) has three flat contact tabs (6) disposed next to one another for activating or supplying motor (12) as well as one further component, such as, for example, a sensor in housing (1). Contact pins (4) pass through contact tabs (6) at the punched openings (15) thereof, thus forming an electrically conductive connection.

Also illustrated in FIG. 6 is a mating connector member (24) equipped with a connecting cable (25) and inserted into terminal socket (28). Connector member (24) is sealed by an O-ring (26), the purpose of which is to prevent ingress of dirt into the contact zone. Connector member (24) is equipped in known manner with sockets to receive the front ends of contact tabs (6).

Instead of continuously flat contact tabs (6), contact tabs formed at the end adjacent to connector member (24) as pins or as sockets to receive pins of connector member (24) can also be used.

It should be understood that the pressure-tight contact device according to the present invention, which is described herein in the context of supplying a pressure-tight encapsulated electric motor, can also be used to supply or control other pressure-tight encapsulated devices.

It should be appreciated that motor (12) can also drive a vacuum pump instead of a compressor.

Accordingly, the present invention provides a pressure-tight contact device, especially for use with a pressure-tight encapsulated compressor motor. The contact device is cost effective to manufacture and assemble and is easily adapted for use with various connecting cables.

It will thus be seen that the objects set forth above, among those made apparent from the preceding description, are efficiently attained, and since certain changes may be made in the above constructions without departing from the spirit and scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed is:

1. A pressure-tight contact device for enabling an electrical connection to an electrical device housed in a pressure-tight housing, said contact device comprising an insulator extending through said housing, a seal for sealing said insulator relative to said housing, and a connector shell of insulating material positioned on said insulator and affixed to at least one of said insulator and said housing, said connector shell including a terminal socket for receiving a connecting cable, said terminal socket including at least one contact pin.

2. The pressure-tight contact device of claim 1, wherein said connector shell is one of a set of interchangeable connector shells each having a different configuration suitable for connection of a corresponding connector member of said connecting cable.

3. The pressure-tight contact device of claim 1, wherein said electrical device housed in said housing is a motor for driving a compressor.

4. The pressure-tight contact device of claim 1, wherein said connector shell includes a shroud, said seal includes a first O-ring seal, and said at least one contact pin extends through said insulator, and further comprising a second seal including a second O-ring seal for sealing said at least one contact pin relative to said insulator, at least one contact tab mounted in said connector shell, said at least one contact pin elastically and electrically connected to said at least one contact tab, a third seal including a third O-ring for sealing said connector shell relative to said insulator, and at least one fastener for affixing said connector shell to at least one of said insulator and said housing, said at least one contact tab and said shroud forming said terminal socket for mating with a connector member of said connecting cable.

5. The pressure-tight contact device of claim 4, wherein said at least one contact pin includes at least one tip arranged and constructed to engage at least one opening defined in said at least one contact tab.

6. The pressure-tight contact device of claim 5, wherein said at least one contact tab includes at least one contact face defined by said at least one opening, said at least one contact face bearing against said at least one contact pin to provide an electrical connection between said at least one contact pin and said at least one contact tab.

7. The pressure-tight contact device of claim 4, wherein said at least one contact pin and said at least one contact tab are positioned proximate one another.

8. The pressure-tight contact device of claim 4, further comprising nose members for positioning said at least one contact tab in said connector shell.

9. The pressure-tight contact device of claim 4, wherein said at least one contact tab is held in position in said connector shell by means of a crimp.

10. The pressure-tight contact device of claim 4, wherein said at least one fastener is a bolt.

11. The pressure-tight contact device of claim 4, wherein said at least one fastener is a play-free snap fastener.

12. The pressure-tight contact device of claim 1, wherein said at least one contact pin is electrically connected to said electrical device and to a source of electrical current for supplying said electrical current to said electrical device.

13. The pressure-tight contact device of claim 12, wherein said at least one contact pin is electrically connected to at least one additional electrical device disposed in said housing.

14. The pressure-tight contact device of claim 1, further comprising a plurality of projections extending from said at least one contact member arranged and constructed to retain said at least one contact member in said insulator when said at least one contact member is pressed into said insulator.

15. The pressure-tight contact device of claim 1, wherein said connector shell includes a bore defined therein for leak testing.

16. The pressure-tight contact device of claim 1, wherein said connector shell includes a channel defined therein for leak testing, said channel being disposed above said at least one contact tab.
